(19) United States
(12) Patent Application Publication
(10) Pub. No.: US 2021/0324747 A1
(43) Pub. Date: Oct. 21, 2021

(54) BLADE MADE OF COMPOSITE MATERIAL AND HAVING AN ENHANCED EROSION PROTECTION FILM, AND ASSOCIATED PROTECTION METHOD

(71) Applicant: SAFRAN AIRCRAFT ENGINES, Paris (FR)

(72) Inventors: Mathieu Julien CHARLAS, Moissy-Cramayel (FR); Mehdi BAJULAZ, Moissy-Cramayel (FR); Alexandre ALU, Moissy-Cramayel (FR)

(73) Assignee: SAFRAN AIRCRAFT ENGINES, Paris (FR)

(21) Appl. No.: 17/271,394

(22) PCT Filed: Aug. 30, 2019
(86) PCT No.: PCT/FR2019/052004

§ 371 Date: Feb. 25, 2021

(30) Foreign Application Priority Data
Aug. 31, 2018 (FR) 1857853

(51) Int. Cl. F01D 5/28; B29D 99/00

(52) U.S. Cl. CPC F01D 5/282; F01D 5/286; B29D 99/0025; F05D 2230/80; F05D 2240/305; F05D 2230/60; F05D 2300/603

(57) ABSTRACT

A turbomachine blade including a blade body made of fiber-reinforced organic matrix composite material, the blade body having a pressure side and a head provided with an apex; an erosion protection film which is made of a thermoplastic polymer and adhered to the blade body; a reinforcement layer which is made of a thermosetting polymer and positioned on the erosion protection film on the head of the blade.

### TECHNICAL FIELD

The present invention relates to a blade of composite material having a reinforced anti-erosion film near the blade apex, as well as a method for protecting a blade of composite material. The invention is concerned in particular with a fan blade for a turbomachine, especially a turbojet engine.

### State of Prior Art

In the aeronautical field, a turbomachine generally consists of a so-called cold part, comprising a compressor and a low pressure turbine, and a so-called hot part, comprising a compressor and a high pressure turbine. Upstream of the low pressure compressor is located a fan, which is a structure consisting of a rotor composed of large-sized and wide-chord blades and a stator composed of a fan casing. It is set out that the term “upstream” is considered in terms of the main gas flow direction within the turbomachine.

In a turbomachine where weight savings is often actively sought, composite materials are often used to make parts, especially on the so-called cold part, more precisely on the low pressure fan, since the temperature levels are most favourable for the use of organic matrix composite materials. This is why the latest generations of low pressure fans have been developed in composite material, especially fan blades.

Compared with traditional blades of titanium (TA6V), blade of composite materials provide excellent mechanical properties in operation and considerable weight savings for the turbomachine. However, the thermomechanical strength of these blades has to be enhanced by applying different protective elements.

These composite blades have indeed to withstand different types of operating stresses and have especially to ensure impact resistance (of the ingestion, foreign bodies, erosion type, etc.). This impact resistance is commonly ensured by applying metal parts at impact-sensitive places (for example, it is common to use a metal protective edge (usually called a shield or foil), bonded to the leading edge of the blade), a PTFE fabric coating and/or erosion protective elements (paints, polyurethane film).

These composite blades have also to provide resistance to contact type wear of the abradable part of the fan casing. It is remembered that, in order to optimise operating clearances between the blades and the fan casing, the fan casing is coated with a layer of a so-called “abradable” material, generally comprised of a mixture of epoxy resin and micrometric glass beads. During the operation of the turbomachine, the blades may rub against this abradable material, in order to optimise clearances at any point on the casing. However, such contact leads to self-heating of the blades, leading to hyper localised, but irreversible, degradation of the composite, which worsens mechanical properties of the blades. These properties are worsened especially when the fan blades are rotated at high speed.

Thus, wear protection of composite fan blade apex proves to be crucial, especially as engine manufacturers are continually seeking to increase engine performance by reducing operating clearances, especially fan blade apex clearances, thus increasing occurrences of frictional contact points.

Resistance to abradable contact type wear on the fan casing is commonly provided by metal foils disposed at the fan blade apex and completely covering the blade apex.

However, the drawback of using metal foils is that significant additional weight is introduced to the fan blade, which impacts the centrifugal loading of the fan blade and thus the life time of the fan disc and performance of the turbomachine.

For this reason, the latest generation of fan blades made of organic matrix composite material do not include metal foils at the blade apex. This design makes them more vulnerable to damage from contact with the abradable part of the fan casing. In particular, self-heating caused by contact affects the pressure side of the blade, due to the displacement of the blade apex during operation, and in particular it affects the one or more protective elements disposed on the blade to improve its erosion resistance. For example, under the effect of heating, an erosion protective film made of thermoplastic polymer (for example a polyurethane film), bonded to the pressure side of the blade, will have the possibility of creeping at temperatures above 200° C. and when subjected to important centrifugal forces. As a result, in service, pieces of this anti-erosion film can be centrifuged and become detached from the blade, which causes the erosion protection of the blade composite to degrade and therefore calls into question the life time of the blade.

The present invention aims at providing an alternative solution to metal foils. More particularly, the invention aims at enabling the apex of a blade of an organic matrix composite material to be protected from frictional contacts, without having to use metal foils.

### DISCLOSURE OF THE INVENTION

To do this, one object of the invention is a turbomachine blade comprising:
a blade body of fibre-reinforced organic matrix composite material, the blade body having a pressure side and a head provided with an apex;
an erosion protective film of a thermoplastic polymer bonded to the blade body;

characterised in that the blade further comprises, on its head, a reinforcing layer of a thermosetting polymer positioned on the erosion protective film.

By erosion protective film (or anti-erosion film) it is meant a coating which is resistant to erosion and which, by covering a zone of the blade body, protects it against erosion by improving the resistance of this zone to the erosion phenomenon.

Preferably, the blade is a fan blade.

It is remembered that a thermoplastic polymer (or resin) consists of linear or branched chains with covalent bonds, these chains being linked together by weak Van der Waals or hydrogen type bonds. A thermosetting polymer (or resin) consists of cross-linked linear chains, the chains being spatially linked by strong covalent type bonds. A thermosetting polymer becomes irreversibly solid, unlike a thermoplastic polymer, which softens when heated above a given temperature.

This reinforcing layer reinforces the ability of the anti-erosion film to resist contact with the abradable part of the casing.

Another object of the invention is a method of protecting a turbomachine blade against erosion, the blade comprising a blade body of a fibre-reinforced organic matrix composite material, the body having a pressure side and a head with an apex, the method comprising the following successive steps of:

a) assembling, for example by bonding, an erosion protective film of a thermoplastic polymer on the blade body;

b) applying a reinforcing layer of a thermosetting polymer to the head of the blade body, so that it is positioned on the protective film;

c) possibly applying an anti-erosion paint layer on the blade body, so as to cover the protective film and the reinforcing layer.

The application of an anti-erosion paint is a known step; anti-erosion paint is usually chosen from thermosetting polyurethane formulation resins, often associated with thermoplastic polyurethane elastomers. The ratio of the thermosetting part to the thermoplastic part allows a compromise to be found between anti-erosion behaviour and chipping resistance. These so-called finish polyurethane paints are generally associated with primers formulated with epoxy bases.

According to one embodiment of the method according to the invention, the blade is a blade to be repaired comprising a damaged erosion protective film of a thermoplastic polymer, bonded to the blade body, of which at least a portion located near the apex of the blade body is damaged, and step a) is preceded by an operation of removing at least the damaged portion of the damaged protective film.

This embodiment of the method according to the invention makes it possible to develop a solution for repairing a blade of composite material whose anti-erosion film is damaged, in order to restore it in accordance with the certified definition.

According to one alternative of this embodiment, the blade to be repaired being covered with an anti-erosion paint layer, the method further comprises, before the operation of removing said at least one damaged portion of the damaged protective film, an operation of removing this anti-erosion paint layer.

Some preferred but not limiting aspects of the blade and the protection method according to the invention are the following:
the reinforcing layer extends along the apex in the form of a strip and the protective film and the reinforcing layer are arranged only on the pressure side of the blade body.
the protective film is bonded to the blade body with a layer of a thermosetting polymer which is identical to the thermosetting polymer of the reinforcing layer;
the thermosetting polymer of the reinforcing layer is identical to the thermosetting polymer forming the organic matrix of the blade;
the thermosetting polymer of the reinforcing layer is an epoxy resin;
the reinforcing layer is a strip.

Finally, the invention relates to a turbomachine comprising a fan including a plurality of blades according to the invention.

The solution provided by the invention makes it possible to dispense with a metal foil to protect the integrity of the apex of a blade of composite material, by adding a reinforcing layer of thermosetting polymer, preferably of the strip type, disposed along the blade head in order to limit creep and tearing of the thermoplastic polymer anti-erosion film present on the pressure side.

### BRIEF DESCRIPTION OF THE DRAWINGS

Further advantages and characteristics of the invention will become clearer upon reading the following detailed description of preferred embodiments thereof, given by way of non-limiting example, and with reference to the appended drawings among which:

FIG. 1 is a schematic axial cross-section view of a turbofan engine;

FIGS. 2a to 2d represent the steps of an embodiment of the protection method according to the invention;

FIG. 3 is a schematic cross-sectional view along direction I-I of FIG. 2d showing an example of the arrangement of the various elements on the blade body;

FIGS. 4a to 4d represent the steps of another embodiment of the protection method according to the invention.

### DETAILED DISCLOSURE OT PARTICULAR EMBODIMENTS

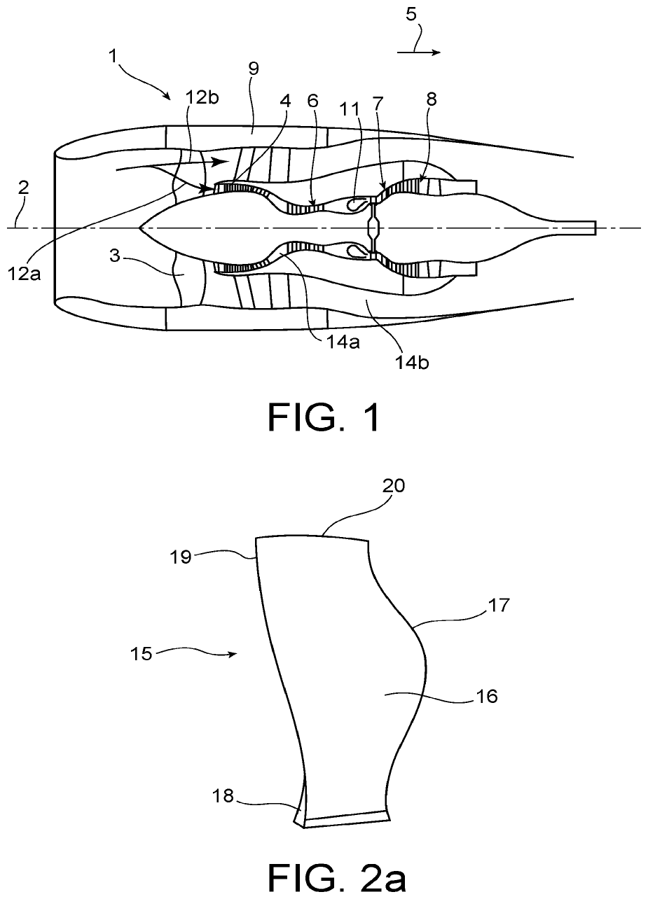

With reference to FIG. 1, a turbomachine 1 is represented, which has a central longitudinal axis 2 about which its various components extend. It comprises, from upstream to downstream along a main direction 5 of gas flow through this turbomachine, a fan 3, a low pressure compressor 4, a high pressure compressor 6, a combustion chamber 11, a high pressure turbine 7 and a low pressure turbine 8.

Conventionally, after passing through the fan, air is divided into a central primary flow 12a and a secondary flow 12b which surrounds the primary flow. The primary flow 12a flows into a main circulation stream 14a of gases passing through compressors 4, 6, combustion chamber 11 and turbines 7, 8. The secondary flow 12b flows in a secondary stream 14b, radially outwardly delimited by a crankcase and surrounded by a nacelle 9.

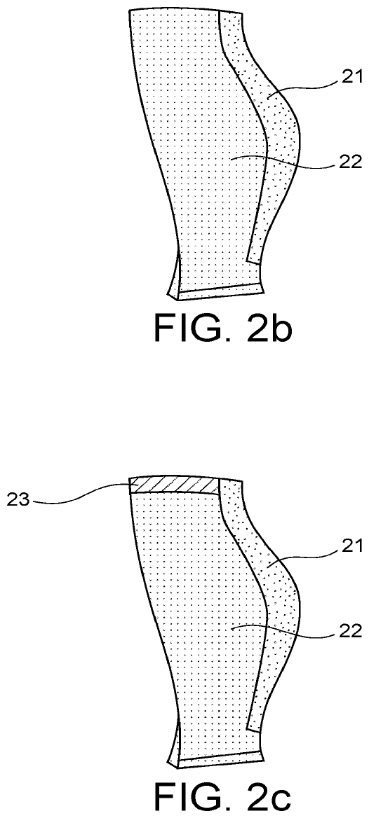

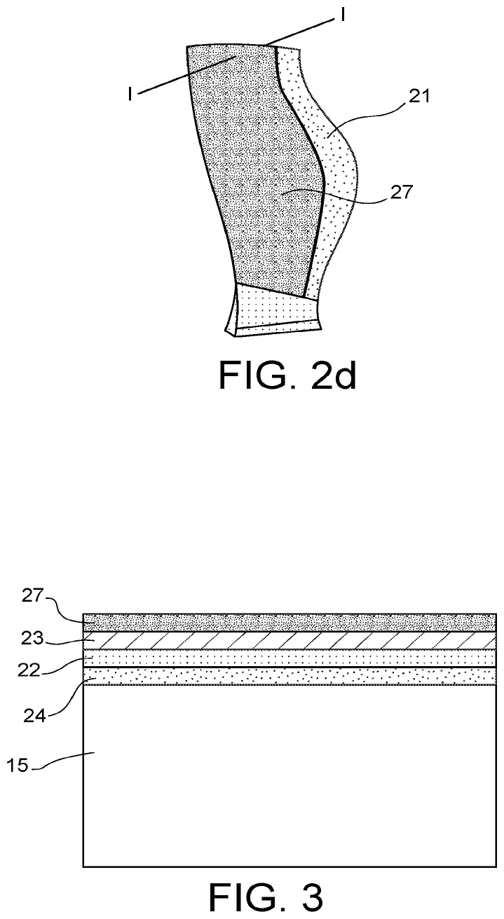

With reference to FIG. 2a, an example of a composite fan blade body 15 for a turbomachine fan is represented. The blade body 15 includes especially a pressure side 16, a suction side (not visible in the Fig.), a leading edge 17, a root 18, a head 19, and an apex 20. The blade body 15 consists of fibres or filaments linked together by a thermosetting resin, for example epoxy resin. The filaments or fibres can be made of carbon or glass, silica, silicon carbide, alumina, etc. The blade body can be obtained, for example, by RTM (Resin Transfer Moulding) injection of a 3D woven preform.

The erosion- and/or impact-sensitive places of this blade body should be protected, especially the leading edge 17, protected in a known manner with a metal shield 21, and the pressure side 16, using an erosion protective film 22 made of thermoplastic polymer, usually a polyurethane film, which is bonded to the pressure side to reinforce it. The use of a thermoplastic film allows the film to be malleable enough to snugly fit the three-dimensional shape of the blade body. On the other hand, however, this film has poor mechanical properties of creep resistance.

The technical solution provided by the invention is to increase creep resistance of the anti-erosion film 22 made of thermoplastic polymer, at least in its portion located close to the apex 20 of the blade, by covering this portion of the film 22 with a reinforcing layer 23 by applying a thin layer of thermosetting polymer. Preferably, the thin-film thermosetting polymer is in the form of a strip, which makes it possible to have the expected result of maintaining the anti-erosion film 22 and increasing its creep resistance, while depositing a minimum quantity of thermosetting polymer so as not to unnecessarily increase the weight of the blade.

The steps of the protection method according to the invention will now be described in detail.

A blade body 15 of an organic matrix composite (OMC) is provided (FIG. 2a).

The metal shield 21 of the leading edge 17 and the anti-erosion film 22 (usually a polyurethane film) are assembled to the blade body 15 (FIG. 2b); assembling can be carried out by bonding, for example by applying an adhesive layer 24 of thermosetting polymer selected from epoxy, polyester, or the like, in film or paste form, with or without support, to the blade body before applying the metal shield and the anti-erosion film thereto. Then it is cured, for example in an autoclave, for 3 hours at 150° C.

A strip of thermosetting polymer is placed on the apex of the blade body on the pressure side of the blade so that the strip covers the erosion protective film (FIG. 2c). This strip will serve as a reinforcing layer 23.

Advantageously, the protection of the blade body is completed by applying an anti-erosion paint 27 to the entire blade body, except for the leading edge shield 21, the upper edge of the blade and the foot 18 (FIG. 2d).

According to a preferred embodiment of the invention, a blade is obtained with a polyurethane film 22 bonded to the pressure side 16 of the blade body using an adhesive, the assembly formed by the film and its adhesive having a thickness of 0.4 mm, a metal shield 21 located on the leading edge 17 of the blade body 15, and a thickness of anti-erosion paint 27 of approximately 0.1 mm deposited onto the entire blade body, especially on the pressure side and suction side parts, with the exception of the metal shield 21, the upper edge of the blade (i. e. its apex 20), as this is not subject to erosion, and the foot 18.

As illustrated in FIG. 3, a multi-layer structure is obtained near the apex 20 of the blade, in a cross-section view. This is because the erosion control film 22 made of thermoplastic polymer (polyurethane film) is sandwiched between two thermosetting polymers, namely the adhesive layer 24 used to bond the anti-erosion film to the blade body and the strip-like reinforcing layer 23, mounted to the apex of the blade body, which results in significantly improving the creep resistance of the anti-erosion film by limiting its movements by delivering rigidity and which also limits the risk of the anti-erosion film tearing off following contact of the blade apex 20 with the abradable material of the fan casing.

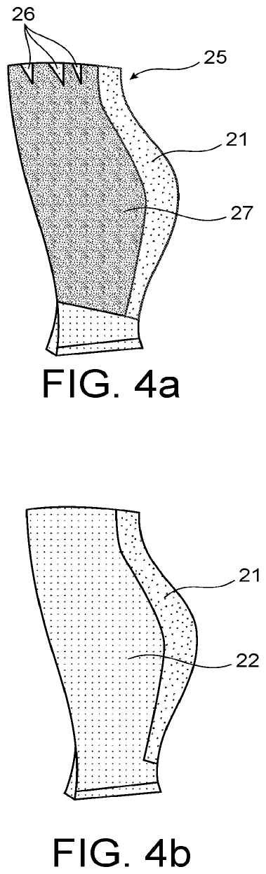

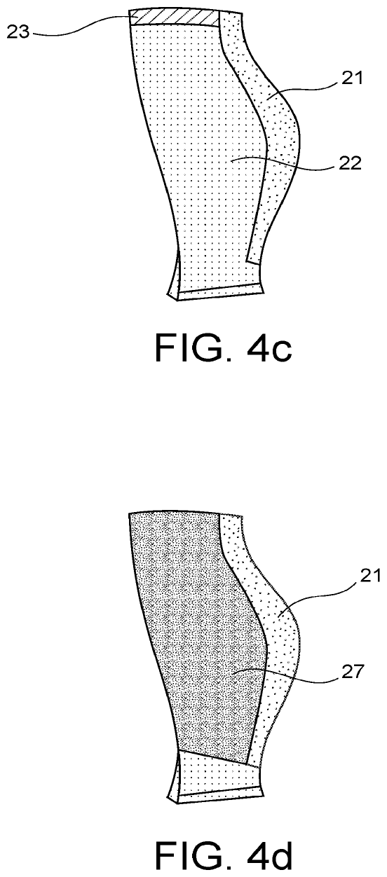

The method according to the invention can also be used to repair a fan blade made of composite material whose apex, not protected against contact with the abradable material, has been damaged (blade to be repaired 25). As illustrated in FIG. 4a, this blade to be repaired 25 shows wear at the apex of the blade in the form of chipped anti-erosion paint, revealing a damaged anti-erosion film 26.

Partial or total removal of the anti-erosion paint 27 is carried out, for example by a stripping method, for example by hand sanding, in order to at least remove the anti-erosion paint in the damaged zone of the damaged erosion film 26 (mainly located near the apex of the blade).

The damaged anti-erosion film 26 is then reconditioned. For this, the damaged anti-erosion film 26 is partially or totally removed, so as to remove the damaged part of the damaged anti-erosion film and a new anti-erosion film 22 is reapplied on the blade body (FIG. 4b).

A reinforcing layer 23 of thermosetting polymer in strip form (FIG. 4c), which is arranged so that it covers the new anti-erosion film 22, is applied to the apex of the blade on the pressure side wall 16, and curing is carried out, for example in an autoclave, applying for example the same parameters as those of the cycle of assembling the leading edge and the anti-erosion film (3 hours at 150° C.).

Finally, advantageously, the anti-erosion paint 27 is applied (FIG. 4d). For example, a primer for finish painting can be applied; then baking of the primer (for example, at 80° C. for 30 minutes) can be performed; then the anti-erosion paint be applied over the primer and autoclave baking be performed (for example, 80° C. for 60 minutes).

It is remembered that controlling the thickness of the fan blades is essential, as it is directly related to the engine performance. Similarly, it is required on standby turbomachines not to deploy a solution that is costly in terms of weight, so as not to degrade the performance of the turbomachine. Thus, the solution provided, whether when protecting a new blade or when protecting a damaged blade (and therefore repairing it), should ensure an acceptable and lasting level of performance in terms of thickness control. In this case, the technical solution provided by the invention makes it possible to satisfy this thickness control criterion by introducing a layer of thermosetting polymer of controllable thickness. Preferably, a layer of thermosetting polymer with a thickness of between 0.05 and 0.15 mm (including the terminals) will be deposited. This application is localised at the apex of the blade, preferably only on the apex of the blade on the pressure side, ensuring a negligible increase in weight of the fan blade as opposed to current solutions aiming at introducing a metal foil at the apex of the blade.

As regards the choice of the thermosetting polymer for the reinforcing layer, it has to take various parameters intrinsic to the fan blade into account.

First of all, the thermosetting polymer chosen for the reinforcing layer has to be able to cross-link during curing without compromising mechanical properties of the fan blade body. For a fan blade body made of carbon fibre reinforced epoxy matrix composite material, epoxy type polymers can be chosen whose properties allow cross-linking at a temperature level equivalent to the polymerisation temperature of the polymer forming the matrix of the blade body. Among the epoxy polymers available on the market, polymerisations range from 70° C. to theoretically 250° C. It should be noted that for use on a LEAP fan blade, made of carbon fibre reinforced epoxy matrix composite material, as a precautionary measure, only epoxy polymers with a maximum polymerisation temperature of 150° C. are used, to respect the health of the composite material. For example, an AF191 type polymer from 3M can be chosen, which cures at around 150° C.

Preferably, the time spent protecting a blade, whether on a new blade or on a damaged blade, should be minimal. Thus, the material of the thermosetting polymer of the reinforcing layer should preferably be chosen so that its cross-linking does not require too long a curing cycle. The use of the same thermosetting polymer as that used for bonding the metal shield of the leading edge or that used for bonding the anti-erosion film (which may be the same as that used for bonding the shield) limits the impact on the time spent protecting the blade.

Finally, the choice of thermosetting polymer for the reinforcing layer should not call into question the resistance of the fan blade to the fluids present in the engine environment (Skydrol™ hydraulic fluid, engine oil, etc.). For other applications (for example bonding of the metal leading edge and/or bonding of the anti-erosion film), the use of a thermosetting polymer already present on the fan blade is therefore favoured, as the thermosetting polymer chosen is thereby already suitable for fluid resistance.

Thus, the solution provided by the invention, namely the application of a thermosetting polymer as a thin layer placed at the apex of the blade straddling the thermoplastic polymer anti-erosion film and the blade body, makes it possible to improve resistance of this anti-erosion film, whether when protecting a new or damaged blade, without having to use a metal foil.

1. A turbomachine blade, comprising:
a blade body of fibre-reinforced organic matrix composite material, the blade body having a pressure side and a head provided with an apex;
an erosion protective film of a thermoplastic polymer, bonded to the blade body;
wherein the blade further comprises, on its head, a reinforcing layer of a thermosetting polymer, positioned on the erosion protective film.

2. A method for protecting a turbomachine blade against erosion, the blade comprising a blade body of fibre-reinforced organic matrix composite material, the body having a pressure side and a head provided with an apex, the method comprising the following successive steps of:
a) assembling, by bonding, an erosion protective film of a thermoplastic polymer on the blade body;
b) applying a reinforcing layer of a thermosetting polymer to the head of the blade body, so that the reinforcing layer is positioned on the protective film.

3. The method according to claim 2, wherein the blade is a blade to be repaired comprising a damaged erosion protective film of a thermoplastic polymer, bonded to the blade body, at least a portion of which located near the apex of the blade body is damaged, and wherein step a) is preceded by an operation of removing at least the damaged portion of the damaged protective film.

4. The method according to claim 3, wherein the method further comprises, after step b), applying an anti-erosion paint layer on the blade body, so as to cover the protective film and the reinforcing layer and wherein the method further comprises, prior to the operation of removing said at least one damaged portion of the damaged protective film, an operation of removing this said anti-erosion paint layer.

5. The blade according to claim 1, wherein the reinforcing layer extends along the apex in strip form and wherein the protective film and the reinforcing layer are disposed only on the pressure side of the blade body.

6. The blade according to claim 1, wherein the protective film is bonded to the blade body with a layer of a thermosetting polymer which is identical to the thermosetting polymer of the reinforcing layer.

7. The blade according to claim 1, wherein the thermosetting polymer of the reinforcing layer is identical to the thermosetting polymer forming the organic matrix of the blade.

8. The blade according to claim 1, wherein the thermosetting polymer of the reinforcing layer is an epoxy resin.

9. A turbomachine comprising a fan including a plurality of blades according to claim 1.
